(19) United States
(12) Patent Application Publication
(10) Pub. No.: US 2003/0225615 A1
(43) Pub. Date: Dec. 4, 2003

(54) Point pass-on system

(76) Inventor: Tokihiro Sumiyoshi, Aichi Prefecture (JP)

Correspondence Address: JENNER & BLOCK, LLC, ONE IBM PLAZA, CHICAGO, IL, 60611, US

(21) Appl. No.: 10/162,024

(22) Filed: Jun. 4, 2002

(51) Int. Cl. G06F 17/60

(52) U.S. Cl. 705/14

(57) ABSTRACT

A point pass-on system is provided which permits users to utilize points without restrictions on use units and purposes and increase a point recovery rate. The amount of points held by a user is converted to reference points based on a conversion rate stored in a conversion rate database, and the reference points are stored in a member database. A content providing unit collects a participation fee from the user by the reference points and provides the user with content such as a game, auction, survey, contest or the like. A point management unit 16 manages the participation fee and the balance of bet as well when the content is accompanied by a bet, and accumulates all the reference points consumed thereby as consumed points in a point consumption database. The point management unit distributes the consumed points stored in the point consumption database to virtual shops and real shops and notifies them of the distribution. Since the points are consumed, the shops can issue new points without new investments.

### BACKGROUND OF THE INVENTION

1. Field of the Invention

The present invention relates to a point pass-on (or redemption) system, and more particularly, for a point pass-on system for effectively utilizing and redeeming points issued by virtual organizations such as virtual shops on the Internet, and real organizations such as real shops like department stores.

2. Description of the Prior Art

The number of customers visiting web pages provided by web sites such as electronic commerce sites, game providing sites, music delivery sites and the like on the Internet, i.e., virtual shops, directly relates to the valuation and revenue of the virtual shops. It is, therefore, a subject of shop managers to increase the number of customers visiting their virtual shops. As a means for increasing customers to a virtual shop, electronic points are issued associated with a visit of a user to the virtual shop and a transaction with the shop. The user who has accumulated a predetermined amount or more of the electronic points can receive service benefits or privileges provided by the associated virtual shop. There are a variety of service benefits, one of which permits the user to use the electronic points just like cash.

However, since a user receives a relatively low amount or value of electronic points from a virtual shop per electronic trade or the like, the user is forced to spend immense efforts and time for accumulating the electronic points sufficient to receive a service benefit preferred by the user. This is partially because different electronic points are utilized in different virtual shops in principle, and partially because their valid period is relatively short.

For reasons set forth above, at present, the amount of electronic points utilized by users (the amount of benefit provided for users) is extremely low with respect to the amount of issued electronic points. Therefore, the utilization efficiency of the electronic points is too low to sufficiently provide benefits to users, which is the essential object of issuing the electronic points.

Also, the fact that a long period is taken to accumulate enough electronic coupons or points to receive a service benefit, means that there are a huge number of electronic points remaining on the Internet which can be requested for passing them on in the future. Therefore, a virtual shop, which issues the electronic points, must prepare, at all times, service benefits commensurate with the electronic points issued by itself and remaining on the Internet so that the virtual shop can promptly pass the electronic points on to a consumer who requests a service benefit. This causes a burden on the virtual shop's manager.

The foregoing problem is true for points issued by real shops such as real department stores, attraction centers and the like as well as those issued by virtual shops.

### SUMMARY OF THE INVENTION

The present invention has been made in view of the problem inherent to the prior art as mentioned above, and it is an object of the invention to facilitate the distribution of points issued by point issuing organizations such as virtual shops, real shops and the like substantially without restriction on use, units and purposes, thereby improving the point utilization efficiency and pass-on rate.

To achieve the above object, the present invention provides a point pass-on system running in computer software for restoring points issued by virtual organizations and/or real organizations to the organizations. The system includes:

conversion rate storing means for storing conversion rates of converting points issued by the organizations to reference points, the conversion rates being stored correspondingly to the organizations;

point calculating means for converting points issued by each of the organizations and held by a member or affiliate to the reference points with reference to the associated conversion rate in the conversion rate storing means;

member information storing means for storing member information including points issued by organizations and held by a member, and held reference points converted from the points;

content providing means for collecting a participation fee from a member by reference points, and providing the member with a content, wherein the reference points of the participation fee are subtracted from the held reference points of the member stored in the member information storing means; and

point confirmation/consumption notification means for confirming between each of the organizations and the point pass-on system whether or not points declared by a member are held by the member, and for notifying each of the organizations of points consumed in the point pass-on system,

wherein the point calculating means is further configured to calculate an accumulated amount of participation fees collected from members as consumed points for each of the organizations.

Preferably, in the point pass-on system according to the present invention, the content providing means provides contents including a game content in which a member can participate only when the member pays a bet by reference points. Further, it is preferable for the point calculating means to calculate bets accumulated when no winner is determined in execution of the game content, as consumed points for each of the organizations in addition to the accumulated amount of participation fees collected from members.

### BRIEF DESCRIPTION OF THE DRAWINGS

FIG. 1 is an block diagram generally illustrating a network-based point pass-on system according to the present invention; and

FIG. 2 is a flow chart for explaining the operation of the point pass-on system according to the present invention.

### DETAILED DESCRIPTION OF THE EMBODIMENT

First, the description begins with the concept of a point pass-on system according to the present invention. The system of the present invention is built as a web site on the Internet and makes a contract, on a one-to-one basis, with a point issuing organization such as a virtual shop, a real shop or the like which issues points. The system evaluates the points issued by the organizations or shops, and determines a conversion rate to a reference point for each organization. The system also registers users who hold the points of these shops as members or affiliates, and makes good use of the nature of the virtual space on the Internet. Namely, the system operates at an actually unavailable speed, and provides content such as contests, games, surveys, auctions and the like in which a large number of users can simultaneously participate. The system collects reference points of minimum units as participation fees from users who participate in such contests. In this way, a large amount of reference points can be recovered in a short time in the form of participation fees, because a large number of point holders can participate in the games and other programs.

For providing a game content, the system collects the reference points from participants as bets, and gives all the bets to the winner of the game as a premium. When there is no winner, the system can recover the reference points corresponding to the bets. Recovered points can be regarded as spent, i.e., consumed.

With the point pass-on system, the user can enjoy a variety of content using a small amount of points which would be normally left unused. Also, since the user can acquire a large amount of reference points when he or she wins a game or the like, the user has a point value sufficient to pass on and therefore can exchange the obtained points for a service benefit. On the other hand, a virtual shop, a real shop or the like, which issues the points, can newly issue points corresponding to the consumption value without providing new funds.

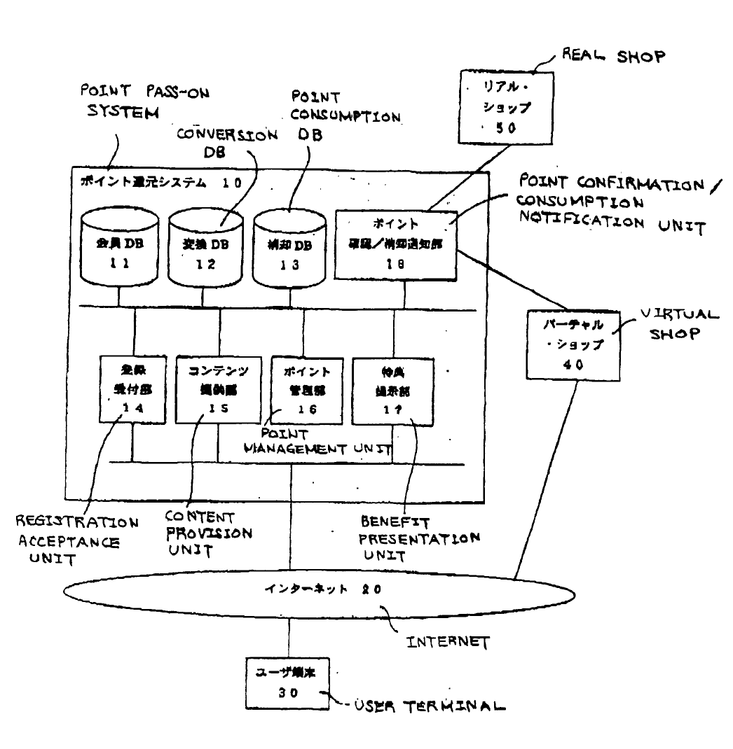

FIG. 1 illustrates a general block diagram of a network including a point pass-on system according to the present invention. In FIG. 1, the network includes the point pass-on system 10 according to the present invention; the Internet 20; a user (member) terminal 30; a virtual shop 40 on the Internet; and a real shop 50. Although only one user terminal 30 is illustrated, a plurality of user terminals may be connected to the point pass-on system. Similarly, a plurality of virtual shops and real shops are contemplated. In this specification, the term “virtual shop” refers to a web site which comprises a shop for electronic commerce on the Internet or a server providing users with arbitrary content such as games, surveys and the like on web pages, and which provides users with points. Similarly, the term “real shop” refers to a physical shop or other facility which provides users with points.

While the real shop 50 has its terminal (not shown) connected to a point confirmation/consumption notification unit 18 in the point pass-on system 10 through a dedicated line in FIG. 1, it may be connected thereto through the Internet 20.

The point pass-on system 10 comprises a member database (DB) 11 for storing information on users who have been registered as members; a conversion rate DB 12 for storing conversion rates of points respectively issued by the virtual shops 40 and real shops 50 to the reference points; and a point consumption DB 13 for storing accumulated points consumed by users who have utilized the points. The point pass-on system 10 further comprises a registration acceptance unit 14 for accepting member registration from users; a content providing unit 15 for providing members with content such as games, auctions, surveys, contests and the like on web pages; a point management unit 16 for calculating the reference points held by each member; a benefit presentation unit 17 for presenting benefits to members; and the point confirmation/consumption notification unit 18 which communicates with the virtual shops 40 and real shops 50 to confirm points issued by these shops and held by members, and notify the shops and members of amounts of recovered or consumed points.

In the point pass-on system 10, when a user accesses the home page of the system 10 to register as a member on a page provided by the registration acceptance unit 14, the name and identification number (user ID and/or password) of the user, type of held points (issuer), and amount of points are entered by the user or determined between the user and the system 10. The entered information is stored in the member DB 11. Then, the point management unit 16 converts one or plural types of points (issued by the virtual shops 40 and/or real shops 50) held by each member to reference points with reference to the conversion rates for respective issuers stored in the conversion rate DB 12. The total amount of calculated reference points is stored in the member DB 11 as the amount of member held reference points.

The point confirmation/consumption notification unit 18, in response to a request from the registration acceptance unit 14, communicates with the virtual shop(s) 40 and/or real shop(s) 50 to confirm whether or not the type(s) and amount of points declared by the user are actually and currently held by the user.

When registered as a member, the user can access web pages provided by the content providing unit 15 of the point pass-on system 10 from the user terminal 30, and can therefore enjoy content by paying predetermined reference points set as a participation fee for each type of content. As the user pays the participation fee, the point management unit 16 subtracts the amount of reference points corresponding thereto to update the amount of member held reference points associated with the user in the member DB 11. The unit 16 further adds the amount of reference points to the accumulated consumed point value in the point consumption DB 13 to update the accumulated consumed value.

Even after registered as a member, the user can add all or part of points, when acquiring from the virtual shop(s) 40 and/or real shop(s) 50, to points held by the user on the page provided by the registration acceptance unit 14. The added points are converted to the reference points which are added to the member held reference points in the member DB 11. When each member has the reference points equal to or larger than a certain predetermined value, the member can request a conversion of the held reference points to a service benefit on a page presented by the benefit presentation unit 17.

Here, description will be made on a “sandwich game” which is an example of games provided by the content providing unit 15. This is a card game which is played between a dealer of the content providing unit 15 and a member, i.e., a player. Since this is not a competition game between players, the game does not require a regular connection of a communication line and is not affected by the action of other players. Therefore, any number of players can simultaneously participate in the game, and individual users can adjust the frequency at which he participates in the game.

The sandwich game prescribes the following rules.

A player pays a participation fee (for example, ten reference points) each time the player participates in the game.

When a player attempts to participate in the game, the player first selects a table through four parameters: “dealer name,” “game speed,” “limit of bet (for example, on the order of ten times the participation fee)” and “held point amount of table.”

Upon determination of a table, the player is automatically seated on any of a plurality of seats (for example, five seats A-E). At this time, the participation fee is automatically collected as well.

A dealer uses 40 cards from 1 to 10, and delivers two hand cards to the player.

The player has set the amount of points, which is a bet, until his turn comes around. For example, assuming that a player at C seat is about to draw the third card in his play when a certain player is automatically seated at B seat, the play continues in the order of players on D seat, E seat and A seat. The player at B seat must decide a bet, determining from the two hand cards, until his turn comes around. In this event, the bet should be equal to or less that a limit amount set for each table. If no limit is set for a bet on a table, the bet is the smaller one of the amount of points held by the table or the amount of points (reference points) held by the player himself.

If the third card delivered by the dealer has a value between the two hand cards, the player acquires the same amount as the bet points, and otherwise loses the bet points. The points the user has lost are accumulated in points held by the table.

As the points held by one table reaches a predetermined amount, the game on the table is over.

Assume, for example, such a game is played at a rate of once per second, the participation fee is ten reference points, 100 persons participate in the game on the average, and one person participates in the game every fifth game. In this event, approximately 17,000,000 reference points per day can be accumulated or consumed on the average. The amount of consumed points are distributed in accordance with a proportion previously set for each of the virtual shop 40 and real shop 50, and the amount of distributed consumed points is notified to each of the shops. The winner of the game can acquire reference points corresponding to the bet, and can exchange the reference points for an appropriate premium as mentioned above.

The content providing unit 15 provides members with content such as auction, surveys, contests and the like in addition to games. The contents other than games will be described below in brief.

In an auction, a plurality of members pay a participation fee in the form of reference points to request participation in a bid for an article or a service, and as a result of the auction, a member who made a successful bid pays the reference points corresponding to the highest bid price. The reference points corresponding to the highest bid price are passed to the person who offered the article or service.

In a survey, a plurality of members can state opinions on a single survey. A member can state an opinion by paying a participation fee in the form of reference points. No consideration is offered to a member who stated an opinion.

In a contest, a plurality of members compete for one target, and the contest is terminated at the time a member reaches the target, or several members survive even if no member reaches the target. Participants in the contest also pay a participation fee by reference points. A winner of the contest is provided with a benefit from the benefit presentation unit 17. The benefit may be, e.g., a preset amount of reference points.

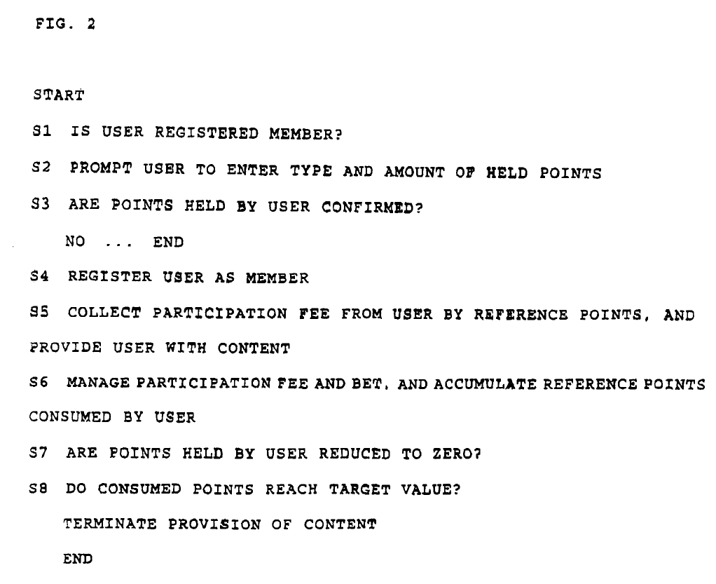

The processing performed when a user accesses the point pass-on system 10 illustrated in FIG. 1 will be described in detail with reference to the flow chart of FIG. 2.

When a user accesses the home page of the point pass-on system 10, the user is asked at step S1 whether or not the user is a registered member. If he or she is not a registered member, the registration acceptance unit 14 presents a member registration page to the user at step S2 to prompt the user to enter the type (issuer) and amount of points held by the user. As the user enters the type and amount of points, the point confirmation/consumption notification unit 18 confirms the points held by the user to the virtual shop(s) 40 and/or real shop(s) 50 which are the issuers of the points at step S3. As the confirmation is made, the user is registered as a member at step S4. In the member registration, a user ID and a password are determined between the registration acceptance unit 14 and the user, and the point management unit 16 references the conversion rate DB 12 to convert the amount of points declared by the user to the corresponding amount of reference points. These data are stored in the member DB 11. If no confirmation is made at step S3, a notification is presented to the user to that effect, followed by the processing for the access made by the user.

When the accessing user is a member, the processing proceeds from step S1 to step S5, where the content providing unit 15 presents the user a content selection page for selecting a game, auction, survey, contest or the like, and presents a selected content. The content selection page shows a reference point amount corresponding to each content as a participation fee, so that the point management unit 16 automatically subtracts the participation fee from the reference points held by the user, stored in the member DB 11, at the time the user selects a content. Also, at step S6, the point management unit 16 manages the balance of bet for each member if a content is a game or the like which is accompanied by a bet. In addition, the point management unit 16 accumulates reference points, consumed when the user utilizes the content, to consumed points in the point consumption DB 13.

After a content is provided, the point management unit 16 monitors remaining reference points held by users within the member DB 11, and determines whether or not the consumed and accumulated points with respect to the content reach a target value at steps S7 and S8. The provision of the content to the user is terminated when the reference points held by the user are reduced to almost zero, or the consumed and accumulated points reach the target value, even if the user desires to continue the access to a content.

As described above, the point management unit 16 distributes the consumed points stored in the point consumption DB 13 to the virtual shops 40 and real shops 50, respectively, at predetermined intervals, irrespective of accesses from users, and notifies the virtual shops 40 and real shops 50 of the distributed consumed points, respectively, through the point confirmation/consumption notification unit 18. The notification may be made after the consumed points are converted by the point rates for the respective shops with reference to the conversion rate DB 12.

Since the present invention is configured as described above, members can enjoy content such as a game and the like by paying a small amount of points as a participation fee, and the points accumulated as the participation fee are consumed. Thus, the points issued by point issuing organizations such as virtual shops, real shops and the like and remaining on the market are consumed, so that these organizations can newly issue points without making a new investment for preparation of point pass-on benefits and the like.

A member, in turn, can enjoy a game content only by paying a bet by points, and can acquire a large amount of points when he or she wins the game. In this way, the member is more likely to acquire the amount of points which can be exchanged for a service benefit or the like.

What is claimed is:

1. A point-pass on system running in computer software for restoring points issued by virtual organizations and/or real organizations to the organizations, the system comprising:
conversion rate storing means for storing conversion rates of converting points issued by the organizations to reference points, the conversion rates being stored correspondingly to the organizations;
point calculating means for converting points issued by each of the organizations and held by a member or affiliate to the reference points with reference to the associated conversion rate in the conversion rate storing means;
member information storing means for storing member information including points issued by organizations and held by a members, and held reference points converted from the points;
content providing means for collecting a participation fee from a member by reference points, and providing the member with a content, wherein the reference points of the participation fees are subtracted from the held reference points of the member stored in the member information storing means; and
point confirmation/consumption notification means for confirming between each of the organizations and the point pass-on system whether or not points declared by a member are held by the member, and for notifying each of the organizations of points consumed in the point pass-on system,
wherein the point calculating means is further adapted to calculate an accumulated amount of participation fees collected from members as consumed points for each of the organizations.

2. A point pass-on system according to claim 1, wherein
the content providing means provides contents including a game content in which a member can participate only when the member pays a bet by reference points, and
the point calculating means is further adapted to calculate bets accumulated when no winner is determined in execution of the game as consumed points for each of the organizations in addition to the accumulated amount of participation fees collected from members.
